(19) United States
(12) Patent Application Publication
(10) Pub. No.: US 2009/0318020 A1
(43) Pub. Date: Dec. 24, 2009

(54) ADAPTER FOR A COAXIAL CABLE CONNECTOR

(75) Inventors: Robert Neil Mulfinger, York Haven, PA (US); John Joseph Consoli, Harrisburg, PA (US); Edmund Luther Jacobs, Harrisburg, PA (US); Richard Allen Burgit, Middletown, PA (US); David Keay Fowler, Boiling Springs, PA (US); Kenneth William Ellis, Etters, PA (US); Alan Anthony Kordas, Lewisberry, PA (US); Troy Conner, York, PA (US); Alice M. Conner, York, PA (US)

Correspondence Address: ROBERT J. KAPALKA;TYCO TECHNOLOGY RESOURCES, 4550 NEW LINDEN HILL ROAD, SUITE 140, WILMINGTON, DE, 19808, US

(73) Assignee: TYCO ELECTRONICS CORPORATION, Berwyn, PA (US)

(21) Appl. No.: 12/145,241

(22) Filed: Jun. 24, 2008

(51) Int. Cl. H01R 9/05

(52) U.S. Cl. 439/578

(57) ABSTRACT

An adapter is provided for mating first and second coaxial cable connectors having first and second receptacle contacts, respectively. The adapter includes an inner electrical contact extending between opposite first and second plug contact end portions. The first plug contact end portion is configured to be received within the first receptacle contact of the first coaxial cable connector. The second plug contact end portion is configured to be received within the second receptacle contact of the second coaxial cable connector. The adapter also includes an outer electrical contact defining a receptacle. The outer electrical contact is configured to hold the inner electrical contact within the receptacle.

### BACKGROUND OF THE INVENTION

The subject matter described and/or illustrated herein relates generally to coaxial cable connectors, and more particularly, to an adapter for coaxial cable connectors.

Due to their favorable electrical characteristics, coaxial cables and connectors have grown in popularity for interconnecting electronic devices and peripheral systems. Coaxial cable connectors typically include an inner electrical contact coaxially disposed within an outer electrical contact of an electrically conductive housing, with a dielectric material separating the inner electrical contact and the electrically conductive housing. The inner electrical contact terminates the end of an inner electrical conductor of the coaxial cable, while the electrically conductive housing terminates an outer electrical conductor of the coaxial cable that is coaxial with the inner electrical conductor. The outer electrical conductor of the coaxial cable and the electrically conductive housing of the coaxial cable connector typically serve as the ground path.

One known standard of coaxial connectors is typically referred to as an ultraminiature coax connector (UMCC). The outer electrical contact of UMCCs either functions as a receptacle having an inner diameter of approximately two millimeters or a plug having an outer diameter of approximately two millimeters. Specifically, with regard to two UMCCs that are configured to be mated together, a first of the UMCCs includes an outer electrical contact that has an outer diameter of approximately two millimeters and the second of the UMCCs includes an outer electrical contact that has an inner diameter of approximately two millimeters such that the outer electrical contact of the first UMCC is configured to be received within the outer electrical contact of the second UMCC. However, when two UMCCs each have outer electrical contacts with the same outer diameter and/or the same inner diameter, the two UMCCs cannot be mated together.

There is a need for an adapter that allows two substantially identical coaxial connectors to mate with each other

### BRIEF DESCRIPTION OF THE INVENTION

In one embodiment, an adapter is provided for mating first and second coaxial cable connectors having first and second receptacle contacts, respectively. The adapter includes an inner electrical contact extending between opposite first and second plug contact end portions. The first plug contact end portion is configured to be received within the first receptacle contact of the first coaxial cable connector. The second plug contact end portion is configured to be received within the second receptacle contact of the second coaxial cable connector. The adapter also includes an outer electrical contact defining a receptacle. The outer electrical contact is configured to hold the inner electrical contact within the receptacle.

In another embodiment, an adapter is provided for mating first and second coaxial cable connectors having first and second receptacle contacts, respectively. The adapter includes an inner electrical contact extending between opposite first and second plug contact end portions. The first plug contact end portion is configured to be received within the first receptacle contact of the first coaxial cable connector. The second plug contact end portion is configured to be received within the second receptacle contact of the second coaxial cable connector. The adapter also includes an insulating member configured to hold the inner electrical contact, and an outer electrical contact defining a receptacle. The outer electrical contact is configured to hold the insulating member within the receptacle.

In another embodiment, a coaxial cable connector includes a housing defining an outer electrical contact, an insulating member held by the outer electrical contact, a receptacle contact held by the insulating member, and an adapter including a radially outer adapter contact defining a receptacle. The radially outer adapter contact is engaged with the outer electrical contact. An adapter insulating member is held within the receptacle by the radially outer adapter contact. A radially inner adapter contact extends between opposite first and second plug contact end portions and is held by the adapter insulating member. The first plug contact end portion of the radially inner adapter contact is received within the receptacle contact.

### BRIEF DESCRIPTION OF THE DRAWINGS

FIG. 1 is a perspective view of an exemplary embodiment of coaxial cable connector illustrating the coaxial cable connector terminating the end of a coaxial cable.

FIG. 2 is a cross-sectional view of the coaxial cable connector and coaxial cable shown in FIG. 1 taken along line 2-2 of FIG. 1.

FIG. 3 is a cross-sectional view of the coaxial cable connector and the coaxial cable shown in FIGS. 1 and 2 taken along line 3-3 of FIG. 1.

FIG. 4 is a perspective view of an exemplary alternative embodiment of a coaxial cable connector illustrating the coaxial cable connector mounted on a substrate.

FIG. 5 is an exploded perspective view of an exemplary embodiment of an adapter for mating the coaxial cable connector shown in FIGS. 1-3 with another coaxial cable connector having an inner electrical contact that is a receptacle contact.

FIG. 6 is a cross-sectional view illustrating the adapter shown in FIG. 5 in an assembled state.

FIG. 7 is a partially exploded perspective view the coaxial cable connector shown in FIGS. 1-3 and a portion of the adapter shown in FIGS. 5 and 6 illustrating installation of the adapter within the coaxial cable connector.

FIG. 8 is another perspective view illustrating installation of the adapter shown in FIGS. 5 and 6 within the coaxial cable connector shown in FIGS. 1 -3.

FIG. 9 is a perspective view illustrating the adapter shown in FIGS. 5 and 6 installed within the coaxial cable connector shown in FIGS. 1-3.

FIG. 10 is a cross-sectional view taken along line 10-10 of FIG. 9.

FIG. 11 is a perspective view of an exemplary embodiment of a coaxial cable connector assembly illustrating the coaxial cable connector shown in FIGS. 1-3 mated with another coaxial cable connector using the adapter shown in FIGS. 5 and 6.

FIG. 12 is a partially broken-away perspective view illustrating a cross section of the coaxial cable connector assembly shown in FIG. 11 taken along line 12-12 of FIG. 11.

### DETAILED DESCRIPTION OF THE INVENTION

As used herein, “coaxial cable connector” refers to any electrical connector that either terminates a coaxial cable or is configured to mate with an electrical connector that terminates a coaxial cable.

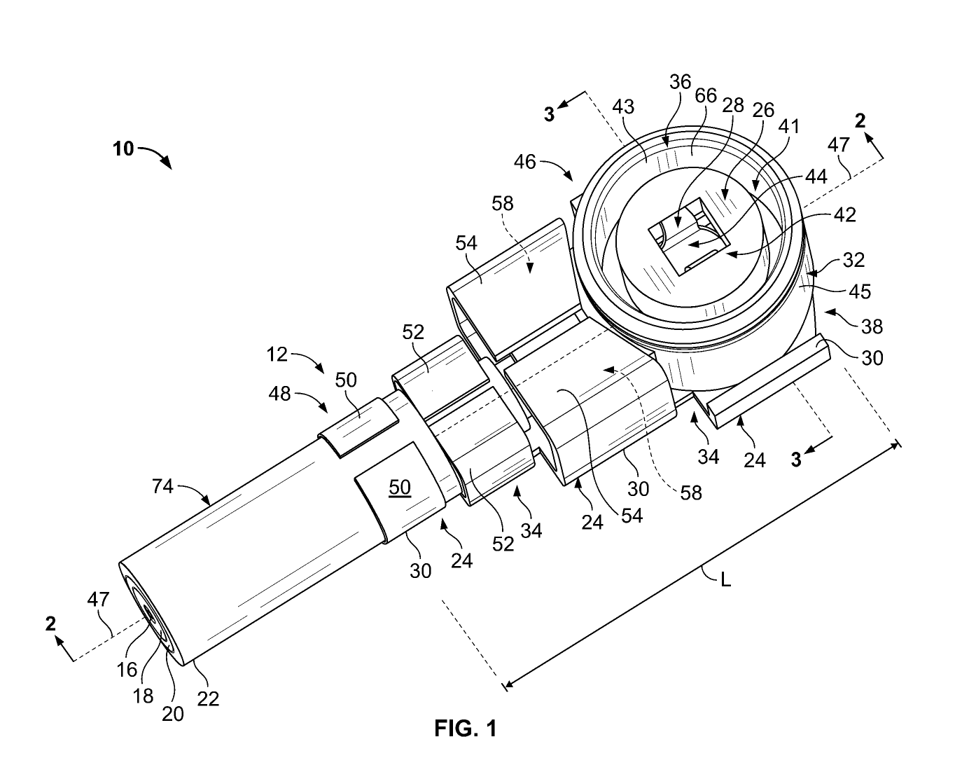

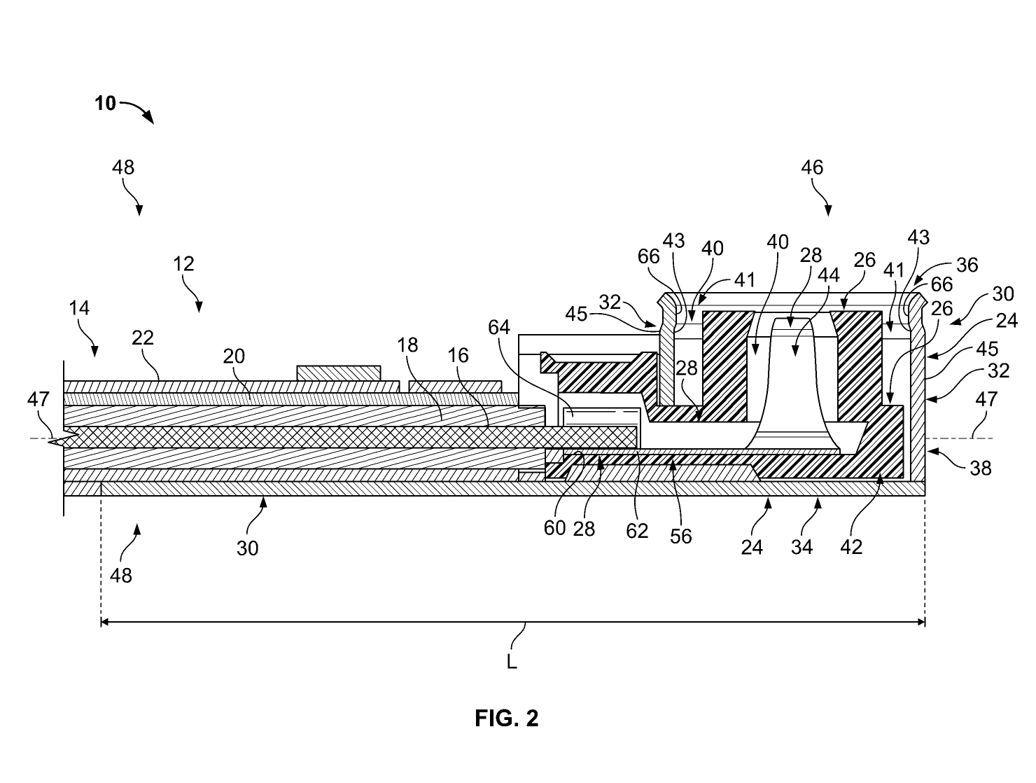

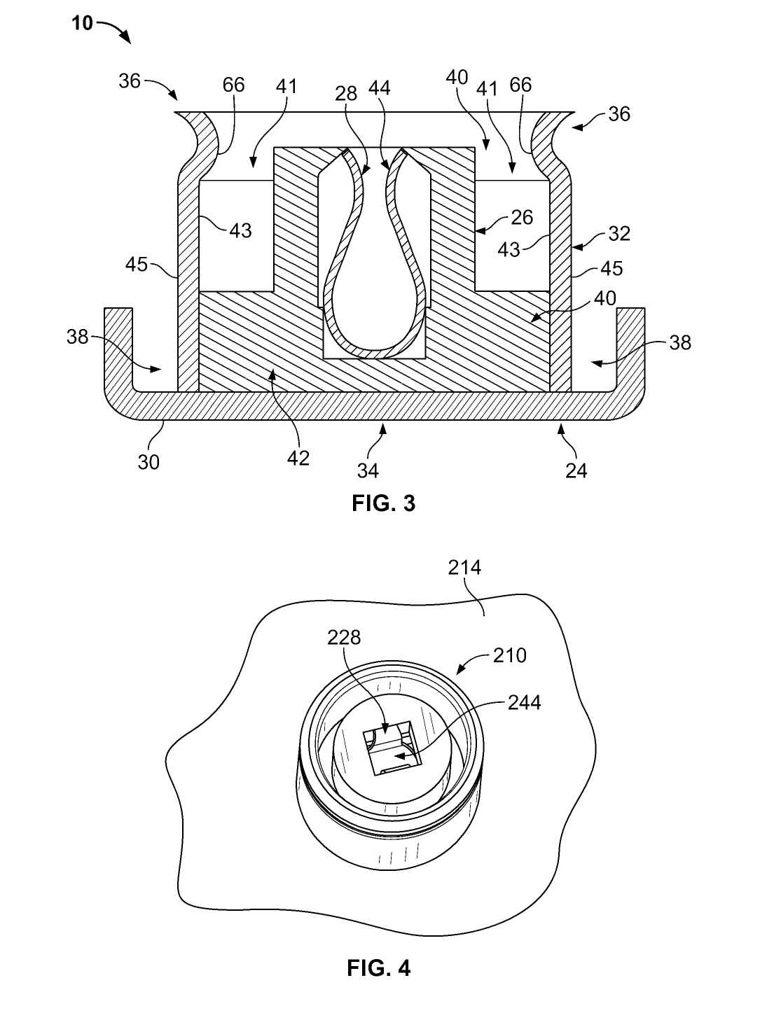

FIG. 1 is a perspective view of an exemplary embodiment of a coaxial cable connector 10 illustrating the coaxial cable connector 10 terminating the end 12 of a coaxial cable 14. FIGS. 2 and 3 are cross-sectional views of the coaxial cable connector 10 and coaxial cable 14 taken along lines 2-2 and 3-3, respectively, of FIG. 1. As can be seen in FIG. 2, the coaxial cable 14 includes an inner electrical conductor 16, an insulating member 18 surrounding the inner electrical conductor 16, an outer electrical conductor 20 surrounding the insulating member 18, and an insulating cover 22 surrounding the outer electrical conductor 20. The inner electrical conductor 16, the insulating member 18, the outer electrical conductor 20, and the insulating cover 22 are coaxial, with the insulating member 18 positioned radially outward from the inner electrical conductor 16, the outer electrical conductor 20 positioned radially outward from the insulating member 18, and the insulating cover 22 positioned radially outward from the outer electrical conductor 20. In the exemplary embodiment, the inner electrical conductor 16 is a signal path while the outer electrical conductor 20 is a ground path. However, alternatively the inner electrical conductor 16 may be a ground path while the outer electrical conductor 20 is a signal path.

The coaxial cable connector 10 includes an electrically conductive housing 24, an insulating member 26 held by the housing 24, and an inner electrical contact 28 held by the insulating member 26. As will be described in more detail below, in the exemplary embodiment, the inner electrical contact 28 is a receptacle contact. The housing 24 includes a body 30 having an outer electrical contact 32 and a base 34. The outer electrical contact 32 is coaxial with the inner electrical contact 28 and is positioned radially outward from the inner electrical contact 28. The outer electrical contact 32 extends between a pair of opposite end portions 36 and 38 and defines a receptacle 40. In the exemplary embodiment, the housing 24, and therefore the outer electrical contact 32, is a ground path, while the inner electrical contact 28 is a signal path. Alternatively, the housing 24, and therefore the outer electrical contact 32, is a signal path and the inner electrical contact 28 is a ground path. The coaxial cable connector 10 may be any type of coaxial cable connector. In the exemplary embodiment, the coaxial cable connector 10 is an ultraminiature coax connector (UMCC).

A portion 42 of the insulating member 26 of the coaxial cable connector 10 is held within the receptacle 40 of the outer electrical contact 32. An opening 41 is defined within the receptacle 40 between the insulating member 26 and a radially inner surface 43 of the outer electrical contact 32. The insulating member 26 holds a receptacle contact end portion 44 of the inner electrical contact 28 within the receptacle 40 and electrically isolates the inner electrical contact 28 from the outer electrical contact 32 of the housing 24 as well as portions of the base 34. As will be described in more detail below, the inner electrical contact 28 is engaged with, and thereby electrically connected to, the inner electrical conductor 16 of the coaxial cable 14. The receptacle contact end portion 44 of the inner electrical contact 28 is configured to receive a plug contact end portion (not shown) of the inner electrical contact of another coaxial cable connector that is configured to mate with the coaxial cable connector 10. Similarly, the outer electrical contact 32 is configured to engage an outer electrical contact of the other coaxial cable connector. In some embodiments, the other coaxial cable connector is mounted on a substrate, such as, but not limited to, a circuit board, a panel, and/or the like. In other embodiments, the other coaxial cable connector terminates the end of another coaxial cable. As will be described in more detail below, the outer electrical contact 32 is electrically connected to the outer electrical conductor 20 of the coaxial cable 14 via engagement between the outer electrical conductor 20 and the housing base 34.

In the exemplary embodiment, the radially inner surface 43 of the outer electrical contact 32 is configured to engage a radially outer surface of the other coaxial cable connector that is configured to mate with the coaxial cable connector 10, such that the outer electrical contact 32 is a receptacle contact. Alternatively, a radially outer surface 45 of the outer electrical contact 32 is configured to engage a radially inner surface of the other coaxial cable connector that is configured to mate with the coaxial cable connector 10, such that the outer electrical contact 32 is a plug contact.

The housing 24 extends a length L along a central longitudinal axis 47 between a mating end portion 46 and a cable-receiving end portion 48. The cable-receiving end portion 48 engages the insulating cover 22 of the coaxial cable 14, while the mating end portion 46 is configured to engage the another coaxial cable connector that is configured to mate with the coaxial cable connector 10. In the exemplary embodiment, the outer electrical contact 32 is located at the mating end portion 46 of the housing 24. The base 34 extends the length L along the central longitudinal axis 47 between the mating end portion 46 and the cable-receiving end portion 48. When the coaxial cable connector 10 assembled as shown in FIGS. 1-3, the base 34, at the mating end portion 46, covers, or closes, the end portion 38 (which is initially open) of the outer electrical contact 32 and the base 34 extends outwardly from the outer electrical contact 32 along the coaxial cable 14.

The base 34 of the housing 24 includes a pair of opposite cover tabs 50, a pair of opposite ground tabs 52, and a pair of opposite retention tabs 54. The insulating member 26 includes an extension 56 that extends outwardly from the portion 42 of the insulating member 26 and is received between a pair of extensions 58 of the outer electrical contact 32 of the housing 24. When the coaxial cable connector 10 is assembled as shown in FIGS. 1-3, the extensions 56 and 58 extend outwardly from the insulating member portion 42 and the outer electrical contact 32, respectively, along the base 34 toward the cable-receiving end portion 48 of the base 34. Although only one extension 56 is shown and a pair of extensions 58 is shown, the insulating member 26 and the outer electrical contact 32 may each have any number of extensions 56 and 58, respectively.

The cover tabs 50 extend outwardly from opposite side portions of the base 34. When the coaxial cable connector 10 is assembled as shown in FIGS. 1-3, free end portions of the cover tabs 50 oppose one another, the coaxial cable end 12 engages the base 34 of the housing 24, and the cover tabs 50 are wrapped around a portion of the insulating cover 22. The cover tabs 50 are crimped such that the cover tabs 50 engage the insulating cover 22 to facilitate securing the coaxial cable 14 to the coaxial cable connector 10, as shown in FIGS. 1-3. In an alternative embodiment, the base 34 may include only one cover tab (not shown) that extends from either of the opposite side portions of the base 34 to an end portion that opposes the other side portion. Moreover, the base 34 may alternatively include a continuous cover tab (not shown) that extends from both of the opposite side portions of the base 34. Although one cover tab 50 is shown extending from each of the opposite side portions of the base 34, each of the opposite side portions of the base 34 may include any number of cover tabs 50 extending therefrom.

The retention tabs 54 extend outwardly from opposite side portions of the base 34. When the coaxial cable connector 10 is assembled as shown in FIGS. 1-3, free end portions of the retention tabs 54 oppose one another and the retention tabs 54 are each wrapped around a portion of the corresponding extension 58 of the outer electrical contact 32. The retention tabs 54 are crimped such that the retention tabs 54 engage the extensions 58 and hold the extensions 58 between a portion of the retention tabs 54 and a portion of the base 34. The retention tabs 54 facilitate retaining the outer electrical contact 32 in the position with respect to the base 34 that is shown in FIGS. 1-3. In an alternative embodiment, the base 34 may include only one retention tab (not shown) that extends from either of the opposite side portions of the base 34 to an end portion that opposes the other side portion. Although one retention tab 54 is shown extending from each of the opposite side portions of the base 34, each of the opposite side portions of the base 34 may include any number of retention tabs 54 extending therefrom.

As shown in FIG. 3, at the end 12 of the coaxial cable 14, the outer electrical conductor 20 is exposed from the insulating cover 22, the insulating member 18 is exposed from the outer electrical conductor 20, and the inner electrical conductor 16 is exposed from the insulating member 18. Referring again to FIGS. 1-3, the ground tabs 52 extend outwardly from opposite side portions of the base 34. When the coaxial cable connector 10 is assembled as shown in FIGS. 1-3, free end portions of the ground tabs 52 oppose one another and the ground tabs 52 are wrapped around a portion of the exposed portion of the outer electrical conductor 20 of the coaxial cable 14. The ground tabs 52 are crimped such that the ground tabs 52 engage the exposed portion of the outer electrical conductor 20 of the coaxial cable 14 to electrically connect the outer electrical conductor 20 to the housing 24, and therefore to the outer electrical contact 32 of the housing 24. Engagement between a portion of the base 34 and the exposed portion of the outer electrical conductor 20 of the coaxial cable 14 also electrically connects the outer electrical conductor 20 to the housing 24, and therefore to the outer electrical contact 32 of the housing 24.

In an alternative embodiment, the base 34 may include only one ground tab (not shown) that extends from either of the opposite side portions of the base 34 to an end portion that opposes the other side portion. Moreover, the base 34 may alternatively include a continuous ground tab (not shown) that extends from both of the opposite side portions of the base 34. Although one ground tab 52 is shown extending from each of the opposite side portions of the base 34, each of the opposite side portions of the base 34 may include any number of ground tabs 52 extending therefrom.

As can be seen in FIG. 2, the extension 56 of the insulating member 26 holds a portion of the inner electrical contact 28 within an opening 60 of the insulating member 26 and electrically isolates the inner electrical contact 28 from the base 34 and the outer electrical contact 32 of the housing 24. The inner electrical contact 28 engages the exposed portion of the inner electrical conductor 16 to electrically connect the inner electrical contact 28 of the coaxial cable connector 10 with the inner electrical conductor 16 of the coaxial cable 14. The inner electrical contact 28 may have any suitable size, shape, geometry, and/or the like, and may engage the exposed portion of the inner electrical conductor 16 in any suitable configuration, arrangement, using any suitable structure and/or means, and/or the like. In the exemplary embodiment, the inner electrical contact 28 includes a pair of extensions 62 and 64 that extend from the receptacle contact end portion 44 toward the cable-receiving end portion 48 of the housing 24. The exposed portion of the inner electrical conductor 16 is clamped between the extensions 62 and 64 to electrically connect the inner electrical conductor 16 to the inner electrical contact 28. Although the extension 64 is shown as extending from the receptacle contact end portion 44, the extension 64 may alternatively extend from the extension 62, such as, but not limited to, adjacent the free end portion of the extension 62. In an exemplary alternative embodiment, the inner electrical contact 28 includes an opening (not shown) within the receptacle contact end portion 44 that receives the exposed portion of the inner electrical conductor 16 such that the inner electrical conductor 16 engages, and is thereby electrically connected to, the inner electrical contact 28.

The outer electrical contact 32 of the housing 24 may optionally include an extension 66 extending outwardly from the radially inner surface 43 of the outer electrical contact 32 that cooperates with a groove (not shown) of another coaxial cable connector that is configured to mate with the coaxial cable connector 10. Cooperation between the extension 66 and the groove creates a snap-fit connection that may facilitate holding the two coaxial cable connectors together. Additionally or alternatively, the outer electrical contact 32 of the housing 24 may optionally include a groove (not shown) extending within the radially inner surface 43 that cooperates with an extension of another coaxial cable connector that is configured to mate with the coaxial cable connector 10. Moreover, the outer electrical contact 32 of the housing 24 may alternatively include a groove (not shown) or an extension (not shown) extending on the radially outer surface 45 of the outer electrical contact 32 that cooperates with a respective extension or groove of another coaxial cable connector that is configured to mate with the coaxial cable connector 10.

Although the coaxial cable connector 10 is shown herein as terminating the coaxial cable 14, the coaxial cable connector 10 may alternatively be mounted on a substrate, such as, but not limited to, a circuit board, a panel, and/or the like. FIG. 4 is a perspective view of an exemplary alternative embodiment of a coaxial cable connector 210 that is mounted on a substrate 214. The coaxial cable connector 210 includes an inner electrical contact 228 that includes a receptacle contact end portion 244. The substrate 214 may be any suitable structure, means, and/or the like, such as, but not limited to, a circuit board, a panel, and/or the like.

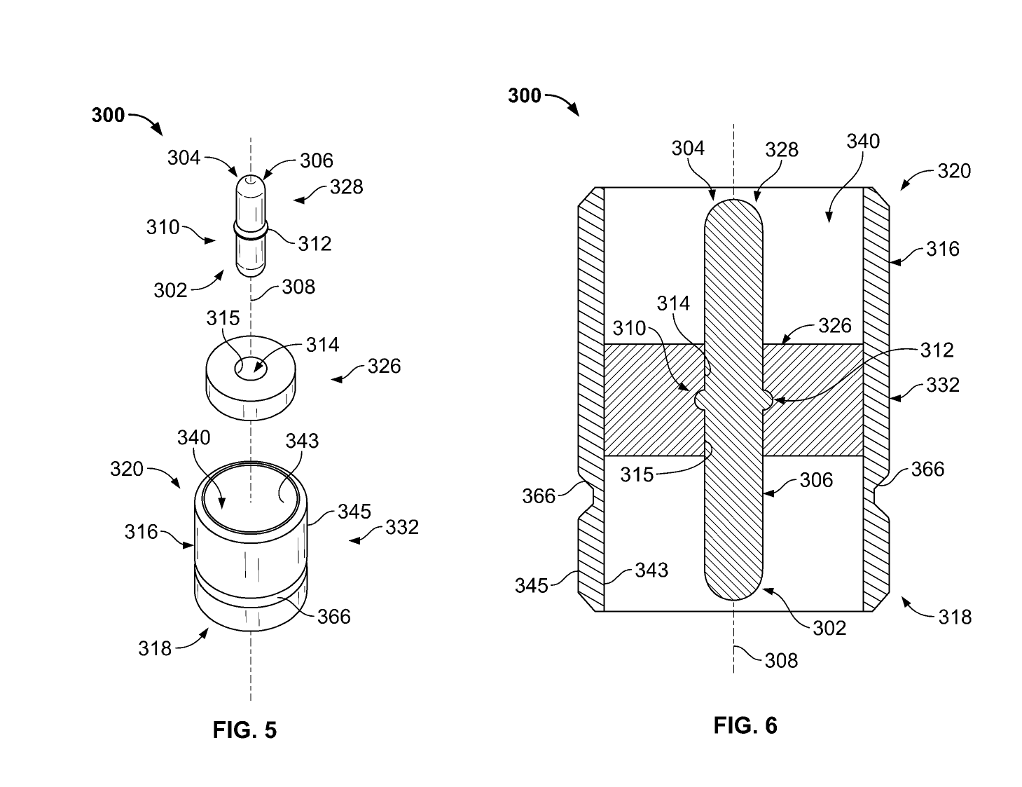

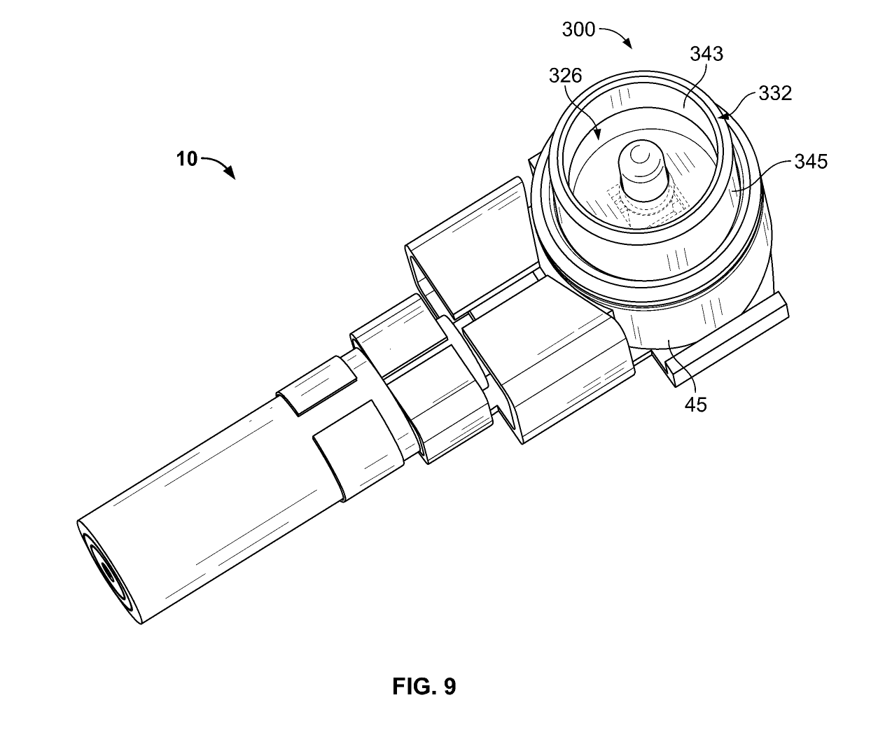

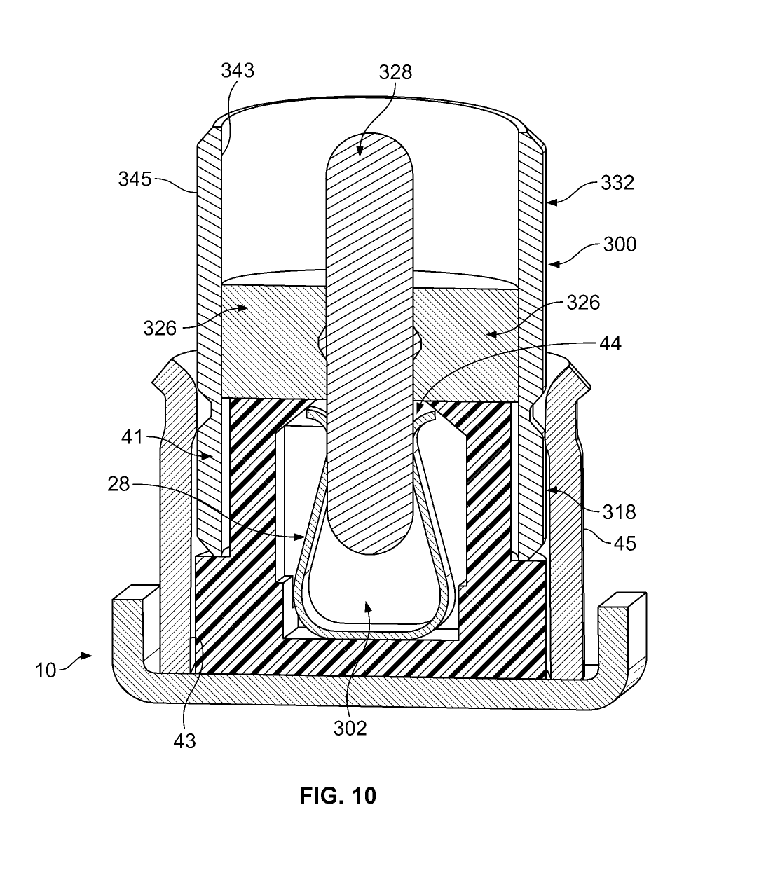

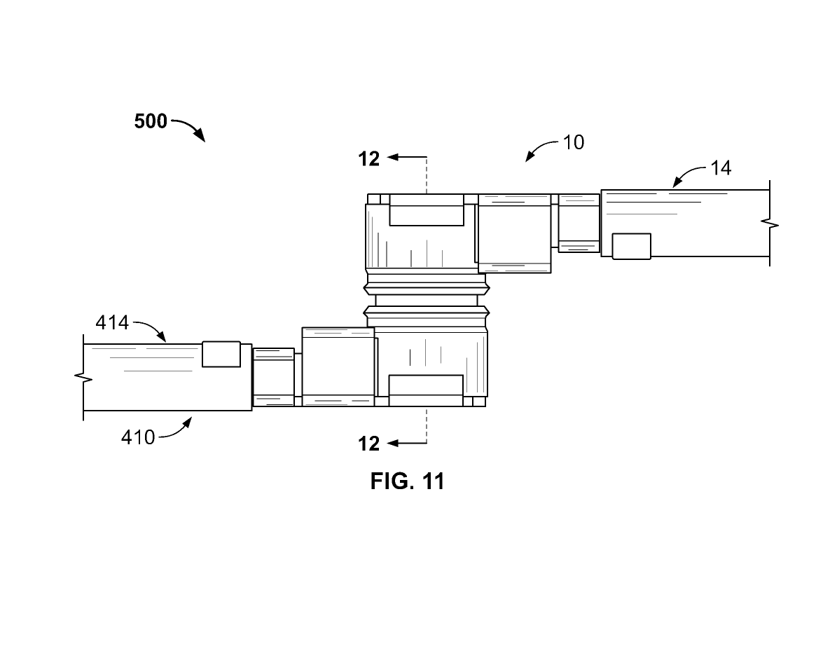

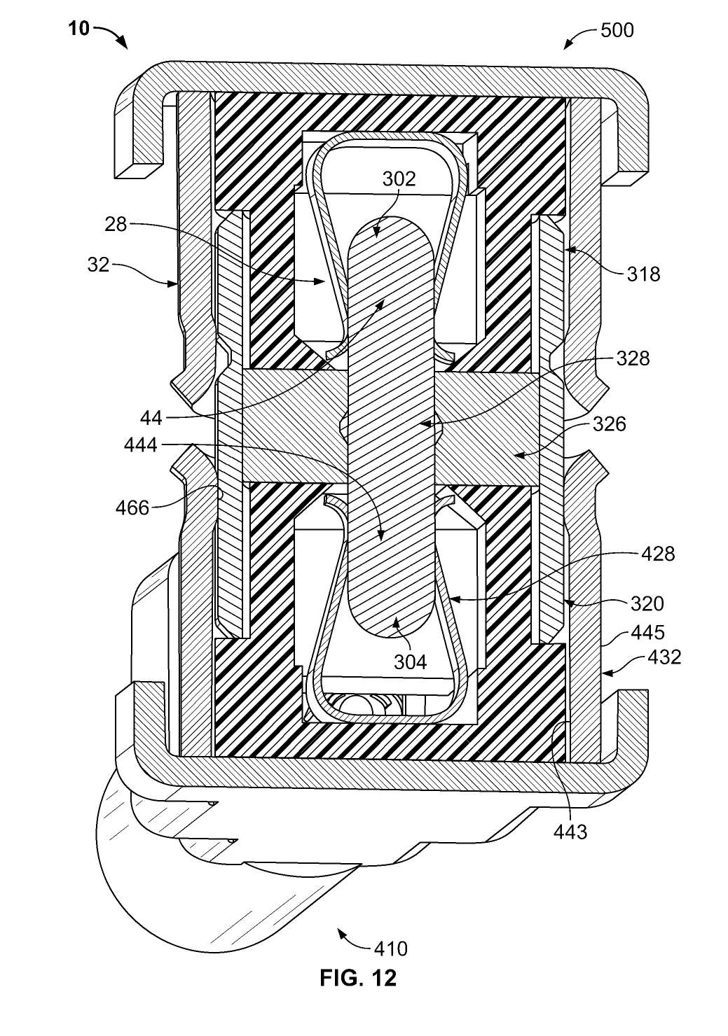

FIG. 5 is an exploded perspective view of an exemplary embodiment of an adapter 300 for mating the coaxial cable connector 10 (FIGS. 1-3 and 7-12) with another coaxial cable connector (such as, but not limited to, the coaxial cable connector 410 shown in FIGS. 11 and 12) having an inner electrical contact (such as, but not limited to, the inner electrical contact 428 shown in FIGS. 11 and 12) that is a receptacle contact. FIG. 6 is a cross-sectional view of the adapter 300 illustrating the adapter in an assembled state. The adapter 300 includes an inner electrical contact 328, an outer electrical contact 332, and an insulating member 326. The radially inner and outer electrical contacts 328 and 332, respectively, may be referred to herein as a “radially inner adapter contact” and a “radially outer adapter contact”, respectively. The insulating member 326 may be referred to herein as an “adapter insulating member”.

The inner electrical contact 328 extends between opposite plug contact end portions 302 and 304. As described in more detail below, the plug contact end portion 302 is configured to be received by the receptacle contact end portion 44 (FIGS. 1-3 and 7-12) of the inner electrical contact 28 (FIGS. 1-3 and 7-12) of the coaxial cable connector 10 such that the inner electrical contact 328 is electrically connected to the inner electrical contact 28. The plug contact end portion 304 is configured to be received by the receptacle contact end portion (such as, but not limited to, the receptacle contact end portion 444 shown in FIG. 12) of the inner electrical contact (such as, but not limited to, the inner electrical contact 428 shown in FIGS. 11 and 12) of the other coaxial cable connector (such as, but not limited to, the coaxial cable connector 410 shown in FIG. 12) such that the inner electrical contacts of the coaxial cable connector 10 and the other coaxial cable connector are electrically connected together.

The inner electrical contact 328 includes a body 306 extending along a central longitudinal axis 308 between the end plug contact end portions 302 and 304. An intermediate portion 310 joins the plug contact end portions 302 and 304. Specifically, the plug contact end portions 302 and 304 extend outwardly from the intermediate portion 310 in opposite directions along the central longitudinal axis 308. The intermediate portion 310 may optionally include one or more extensions 312 to facilitate being held by the insulating member 326.

The insulating member 326 holds the inner electrical contact 328 and electrically isolates the inner electrical contact 328 from the outer electrical contact 332. The insulating member 326 includes an opening 3 14 for receiving the intermediate portion 310 of the inner electrical contact 328. In the exemplary embodiment, an interior surface 315 of the opening 314 engages the extension 312 to facilitate holding the inner electrical contact 328. The outer electrical contact 332 includes a body 316 extending along the central longitudinal axis 308 between a pair of opposite contact end portions 318 and 320. The outer electrical contact 332 includes radially inner and outer surfaces 343 and 345, respectively. The radially inner surface 343 defines a receptacle 340 in which the insulating member 326, and thus the inner electrical contact 328, is held. Specifically, the inner electrical contact 328 is held within the receptacle 340 coaxially, with respect to the central longitudinal axis 308, with the outer electrical contact 332.

The contact end portion 318 is configured to engage the outer electrical contact 32 (FIGS. 1-3 and 7-12) of the coaxial cable connector 10 such that the outer electrical contact 332 is electrically connected to the outer electrical contact 32. The contact end portion 320 is configured to engage the outer electrical contact (such as, but not limited to, the outer electrical contact 432 shown in FIG. 12) of the other coaxial cable connector (such as, but not limited to, the coaxial cable connector 410) such that the outer electrical contacts of the coaxial cable connector 10 and the other coaxial cable connector are electrically connected together.

The insulating member 326 may be fabricated from any suitable material(s) that enables the insulating member 326 to function as described herein, such as, but not limited to, an epoxy, a potting epoxy, a Uni-form™ Precision Epoxy Preform (commercially available from Multi-Seals, Inc., of Manchester, Conn.), and/or the like.

The outer electrical contact 332 may optionally include a groove 366 extending within the radially outer surface 345 at the contact end portion 318 that cooperates with an extension (not shown) of a coaxial cable connector (such as, but not limited to, the coaxial cable connector 10) that the adapter 300 is used with. Cooperation between the groove 366 and the extension creates a snap-fit connection that may facilitate holding the adapter 300 on the coaxial cable connector. Additionally or alternatively, the outer electrical contact 332 may optionally include an extension (not shown) extending outwardly from the radially outer surface 345 at the contact end portion 3 18 that cooperates with a groove of a coaxial cable connector that the adapter 300 is used with. Moreover, the outer electrical contact 332 may alternatively include a groove (not shown) or an extension (not shown) extending on the radially inner surface 343 that cooperates with a respective extension or groove of a coaxial cable connector that the adapter 300 is used with. In addition or alternatively, the contact end portion 320 of the outer electrical contact 332 may include a groove (not shown) or an extension (not shown) on the radially inner or outer surface 343 and 345, respectively, that cooperates with a groove or an extension (such as, but not limited to, the extension 466 shown in FIG. 12) of a coaxial cable connector that the adapter 300 is used with (such as, but not limited to, the coaxial cable connector 410).

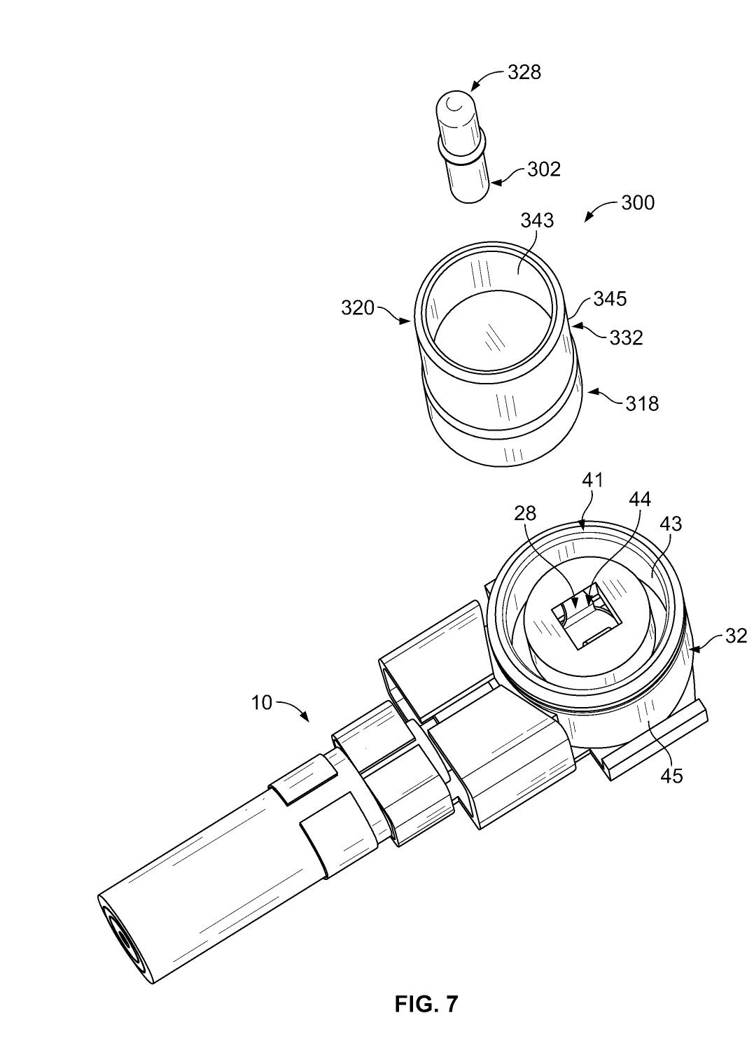

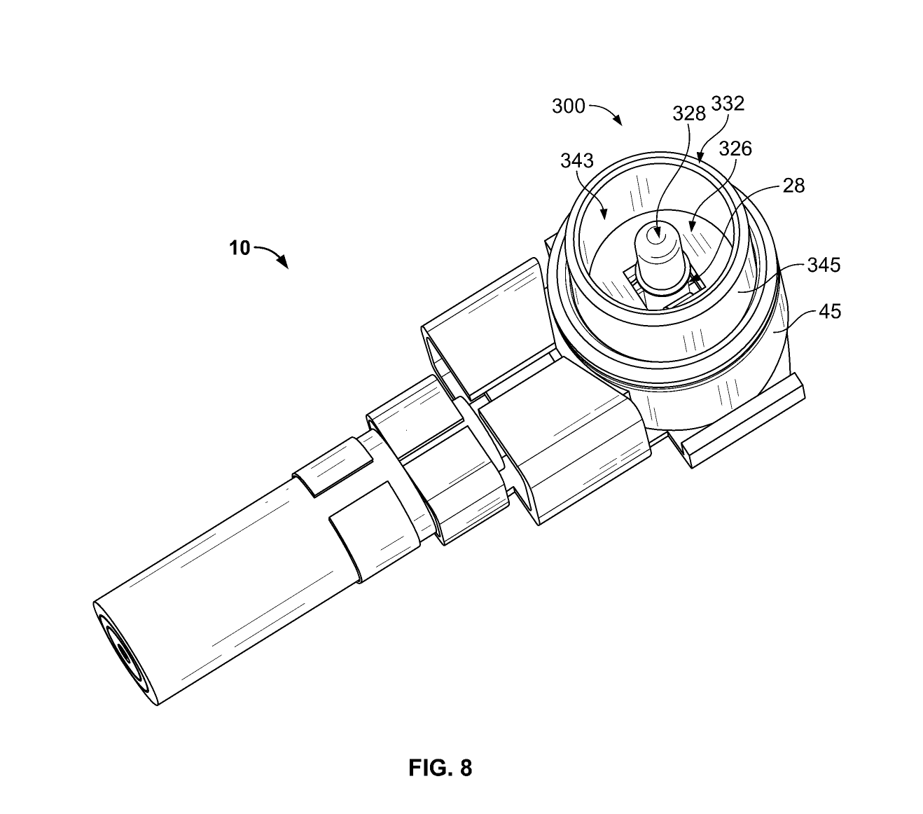

As illustrated in FIGS. 7-12, in the exemplary embodiment, at both of the contact end portions 3 18 and 320, the radially outer surface 345 of the outer electrical contact 332 is configured to engage a radially inner surface (such as, but not limited to, the radially inner surface 43 shown in FIGS. 1-3 and 7-12 and the radially inner surface 443 shown in FIG. 12, respectively) of a coaxial cable connector (such as, but not limited to, the coaxial cable connector 10 and the coaxial cable connector 410) that the adapter 300 is used with, such that the outer electrical contact 332 is a plug contact. Alternatively, at both of the contact end portions 318 and 320, the radially inner surface 343 of the outer electrical contact 332 is configured to engage a radially outer surface (such as, but not limited to, the radially outer surface 45 shown in FIGS. 1-3 and 7-12 and the radially outer surface 445 shown in FIG. 12, respectively) of a coaxial cable connector (such as, but not limited to, the coaxial cable connector 10 and the coaxial cable connector 410) that the adapter 300 is used with, such that the outer electrical contact 332 is a receptacle. In such an alternative embodiment, the radially outer surface 345 of the outer electrical contact 332 may optionally not be cylindrical in shape.

The adapter 300 may, in some embodiments, be assembled as shown in FIG. 6 and then selectively used with different coaxial cable connectors. Alternatively, the adapter 300 could be permanently installed within a coaxial cable connector (such as, but not limited to, the coaxial cable connector 10). For example, referring now to FIGS. 7-10, in some embodiments, the adapter 300 is permanently installed within the coaxial cable connector 10 by inserting the plug contact end portion 302 of the inner electrical contact 328 into the receptacle contact end portion 44 of the inner electrical contact 28 such that the inner electrical contact 328 is electrically connected to the inner electrical contact 28. Similarly, the contact end portion 318 of the outer electrical contact 332 is inserted into the opening 41 of the coaxial cable connector 10 such that the radially outer surface 345 of the outer electrical contact 332 is engaged with, and therefore electrically connected to, the outer electrical contact 32. The insulating member 326 can then be formed within the receptacle 340 and around the intermediate portion 310 of the inner electrical contact 328 to secure the adapter 300 to the coaxial cable connector 10.

FIG. 11 is a perspective view of an exemplary embodiment of a coaxial cable connector assembly 500 illustrating the coaxial cable connector 10 mated together with the coaxial cable connector 410 using the adapter 300. FIG. 12 is a partially broken-away perspective view illustrating a cross section of the assembly 500 taken along line 12-12 of FIG. 11. When the coaxial cable connectors 10 and 410 are mated together as shown in FIGS. 11 and 12, the plug contact end portions 302 and 304 of the inner electrical contact 328 are received into the respective receptacle contact end portions 44 and 444 of the inner electrical contacts 28 and 428, respectively, such that the inner electrical contact 28 of the coaxial cable connector 10 is electrically connected to the inner electrical contact 428 of the coaxial cable connector 410. Similarly, the contact end portions 318 and 320 of the outer electrical contact 332 are engaged with, and therefore electrically connected to, the respective outer electrical contacts 32 and 432 of the coaxial cable connectors 10 and 410, respectively, such that the outer electrical contact 32 is electrically connected to the outer electrical contacts 432.

Although the coaxial cable connectors 10 and 410 are shown in FIGS. 11 and 12 as terminating the coaxial cables 14 and 414, respectively, the coaxial cable connectors 10 or 410 may alternatively be mounted on a substrate, such as, but not limited to, a circuit board, a panel, and/or the like.

The embodiments described and/or illustrated herein provide an adapter for mating together two substantially identical coaxial cable connectors. The embodiments described and/or illustrated herein provide a pair of coaxial cables that may be interconnected via a pair of UMCCs.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

While the subject matter described and/or illustrated herein has been described in terms of various specific embodiments, those skilled in the art will recognize that the subject matter described and/or illustrated herein can be practiced with modification within the spirit and scope of the claims.

1. An adapter for mating first and second ultraminiature coax connectors (UMCCs) having first and second receptacle contacts, respectively, said adapter comprising:
an inner electrical contact extending between opposite first and second plug contact end portions, the first plug contact end portion being configured to be received within the first receptacle contact of the first UMCC, the second plug contact end portion being configured to be received within the second receptacle contact of the second UMCC; and
an outer electrical contact defining a receptacle, the outer electrical contact being configured to hold the inner electrical contact within the receptacle, wherein the outer electrical contact is configured to be mated with a first outer UMCC contact of the first UMCC and a second outer UMCC contact of the second UMCC.

2. The adapter according to claim 1, wherein the outer electrical contact extends between opposite first and second end portions, the outer contact first end portion being configured to be engaged with the first outer UMCC contact of the first UMCC, the outer contact second end portion being configured to engage the second outer UMCC contact of the second UMCC.

3. The adapter according to claim 1, wherein the outer electrical contact comprises a plug contact.

4. The adapter according to claim 1, wherein the outer electrical contact comprises a receptacle contact.

5. The adapter according to claim 1, wherein the outer electrical contact comprises opposite radially inner and outer surfaces, the radially outer surface comprising a cylindrical shape.

6. The adapter according to claim 1, wherein the outer electrical contact is configured to hold the inner electrical contact within the receptacle coaxially with the outer electrical contact.

7. The adapter according to claim 1, wherein the inner electrical contact extends between the opposite first and second plug contact end portions along a central longitudinal axis, the first and second plug contact end portions extending outwardly from an intermediate portion of the inner electrical contact in opposite directions along the central longitudinal axis.

8. The adapter according to claim 1, wherein the outer electrical contact comprises at least one of an outer diameter in the range of approximately one millimeter to approximately four millimeters and an inner diameter in the range of approximately one millimeter to approximately four millimeters.

9. An adapter for mating first and second ultraminiature coax connectors (UMCCs) having first and second receptacle contacts, respectively, said adapter comprising:
an inner electrical contact extending between opposite first and second plug contact end portions, the first plug contact end portion being configured to be received within the first receptacle contact of the first UMCC, the second plug contact end portion being configured to be received within the second receptacle contact of the second UMCC;
an insulating member configured to hold the inner electrical contact; and
an outer electrical contact defining a receptacle, the outer electrical contact being configured to hold the insulating member within the receptacle, wherein the outer electrical contact is configured to be mated with a first outer UMCC contact of the first UMCC and a second outer UMCC contact of the second UMCC.

10. The adapter according to claim 9, wherein the outer electrical contact extends between opposite first and second contact portions, the first contact portion being configured to be engaged with the first outer UMCC contact of the first UMCC, the second contact portion being configured to engage the second outer UMCC contact of the second UMCC.

11. The adapter according to claim 9, wherein the outer electrical contact comprises a plug contact or a receptacle contact.

12. The adapter according to claim 9, wherein the outer electrical contact comprises opposite radially inner and outer surfaces, the radially outer surface comprising a cylindrical shape.

13. The adapter according to claim 9, wherein the outer electrical contact is configured to hold the insulating member such that the inner electrical contact is held within the receptacle coaxially with the outer electrical contact.

14. The adapter according to claim 9, wherein the outer electrical contact comprises at least one of an outer diameter in the range of approximately one millimeter to approximately four millimeters and an inner diameter in the range of approximately one millimeter to approximately four millimeters.

15. The adapter according to claim 9, wherein the inner electrical contact extends between the opposite first and second plug contact end portions along a central longitudinal axis, the first and second plug contact end portions extending outwardly from an intermediate portion of the inner electrical contact in opposite directions along the central longitudinal axis.

16. The adapter according to claim 9, wherein the insulating member comprises an epoxy.

17. A coaxial cable connector comprising:
a housing defining an outer electrical contact;
an insulating member held by the outer electrical contact;
a receptacle contact held by the insulating member; and
an adapter comprising:
a radially outer adapter contact defining a receptacle, the radially outer adapter contact being engaged with the outer electrical contact;
an adapter insulating member held within the receptacle by the radially outer adapter contact; and
a radially inner adapter contact extending between opposite first and second plug contact end portions and being held by the adapter insulating member, the first plug contact end portion of the radially inner adapter contact being received within the receptacle contact.

18. The coaxial cable connector according to claim 17, wherein the coaxial cable connector is mounted on a substrate or terminates the end of a coaxial cable.

19. The coaxial cable connector according to claim 17, wherein the coaxial cable connector is a first coaxial cable connector, the outer electrical contact is a first outer electrical contact, and the receptacle contact is a first receptacle contact, further comprising a second coaxial cable connector comprising a second receptacle contact and a second inner electrical contact, the radially outer adapter contact extending between a first end portion that is engaged with the first outer electrical contact and an opposite second end portion that is engaged with the second outer electrical contact, the second plug contact end portion of the radially inner adapter contact being received within the second receptacle contact.

20. The coaxial cable connector according to claim 17 wherein an opening is defined radially between the insulating member and the outer electrical contact, the radially outer adapter contact extending between a first end portion that is received within the opening and an opposite second end portion.

21. The coaxial cable connector according to claim 17, wherein the coaxial cable connector comprises a right angle connector.
